(19) United States
(12) Patent Application Publication
(10) Pub. No.: US 2023/0196309 A1
(43) Pub. Date: Jun. 22, 2023

(54) DRONE CONTENT SERVICE PLATFORM AND METHOD

(71) Applicant: USIS Co., Ltd., Ulsan (KR)

(72) Inventors: Hyuk Choon KWON, Ulsan (KR); Dong Gun AHN, Ulsan (KR); Sanggu YEO, Ulsan (KR); Il Woo LEE, Ulsan (KR)

(21) Appl. No.: 17/902,808

(22) Filed: Sep. 3, 2022

(30) Foreign Application Priority Data
Dec. 22, 2021 (KR) 10-2021-0184680

(51) Int. Cl. G06Q 20/06; H04N 7/18; H04N 5/232; B64C 39/02

(52) U.S. Cl. CPC G06Q 20/065; H04N 7/185; H04N 5/23203; B64C 39/024; G06Q 2220/00; B64C 2201/146; B64C 2201/127; B64C 2201/122

(57) ABSTRACT

A drone content service platform and method automatically upload images or pieces of video content, which are acquired directly by image acquirers using the cameras of image acquisition terminals mounted on drones, to a blockchain-based platform server. The platform server issues and manages non-fungible tokens (NFTs) for pieces of content and mediates transactions between image acquirers and consumers in a one-to-one sales or one-to-many auction manner, and consumers purchase a plurality of pieces of content managed by the platform server through payment using currency or coins.

### CROSS-REFERENCE TO RELATED APPLICATION

This application claims priority from Korean Patent Application No. 10-2021-0184680 filed on Dec. 22, 2021, which is incorporated herein by reference in its entirety.

### BACKGROUND

### 1. Technical Field

The present invention relates generally to a drone content service platform and method, and more particularly to a drone content service platform and method in which images or pieces of video content acquired directly by image acquirers using the cameras of image acquisition terminals mounted on drones can be automatically uploaded to a blockchain-based platform server, the platform server can issue and manage non-fungible tokens (NFTs) for pieces of content and mediate transactions between image acquirers and consumers in a one-to-one sales or one-to-many auction manner, and consumers can purchase a plurality of pieces of content managed by the platform server through payment using currency or coins.

### 2. Description of the Related Art

Drones refer to unmanned aerial vehicles that can be controlled using radio waves. Such drones are each equipped with a camera, a sensor, and a communication system, and the weight and size thereof range from 25 g to 1200 kg in various manners.

Although such drones were initially developed for military purposes, they have recently been used in various fields such as shooting, surveillance, delivery, pesticide spraying, and air quality measurement. In addition, drones are reborn as low-cost kidult products, so that not only companies but also individuals can purchase drones without significant burden, with the result that various images can be acquired using cameras provided on the drones.

However, the conventional art is problematic in that since there is no drone content platform that can provide content, acquired directly by an image acquirer using a camera mounted on a drone, in a timely manner in response to a request from a consumer, consumers cannot be provided with high-quality content.

Furthermore, the conventional art is problematic in that since a consumer illegitimately copies and distributes content after purchasing the content through the drone content platform, the copyright on the content is infringed and also the profits of an image acquirer who sells the content is deteriorated.

[Related Art Literature]

Patent Document 1: Korean Patent No. 10-2017754

### Patent Document 2: Korean Patent No. 10-1769852

### SUMMARY

The present invention has been conceived to overcome the above-described problems, and an object of the present invention is to provide a drone content service platform and method in which images or pieces of video content acquired directly by image acquirers using the cameras of image acquisition terminals mounted on drones can be automatically uploaded to a blockchain-based platform server, the platform server can issue and manage NFTs for pieces of content and mediate transactions between image acquirers and consumers in a one-to-one sales or one-to-many auction manner, and consumers can purchase a plurality of pieces of content managed by the platform server through payment using currency or coins.

According to an aspect of the present invention, there is provided a drone content service platform including: a drone provided with a gimbal capable of removing the blurring of an image or video content by maintaining a balanced posture regardless of tilt and vibration; an image acquisition terminal provided under the gimbal, and configured to acquire an image or video content via a camera mounted on one side thereof; a drone controller configured to control the flight of the drone; a control terminal connected to the image acquisition terminal, and configured to control the image acquisition terminal so that the camera can acquire content based on a signal input by an image acquirer and to monitor the content acquired by the camera; a wireless communication module configured to transmit and receive signals between the image acquisition terminal and the control terminal; a Bluetooth module configured to transmit drone information, Global Positioning System (GPS) information, and environment information for the history management of the drone to the image acquisition terminal; an radio frequency (RF) communication configured to transmit gimbal control signals, generated by the drone controller, to the drone; a platform server configured to manage a plurality of pieces of content, acquired by the camera, based on a blockchain; and a consumer terminal connected to the platform server through the wireless communication module, and configured to perform content selection and payment request tasks based on signals input by a consumer; wherein, in the image acquisition terminal, content acquired by the camera is automatically stored and also whether to transmit the content to the platform server is selectable; wherein the control terminal is one of a smartphone and smart watch; wherein the drone and the gimbal are connected to each other via wired communication, and transmit and receive gimbal control signals and power signals via wired communication; wherein the drone information is the type of drone, and the owner information and flight date and time of the drone; wherein the GPS information is the altitude, longitude, and latitude of a flight area; and wherein the environment information is the temperature, humidity, and weather of the flight area.

The platform server may include: a transceiver configured to transmit and receive data between the platform server and the drone and between the control terminal and the consumer terminal; an editing unit configured to edit content acquired by the camera; a token issuance unit configured to issues a non-fungible token (NFT) to content in response to a request from an image acquirer; a cloud server configured to store content edited by the editing unit and an NFT issued to the content; and a history management unit configured to register and manage pluralities of pieces of drone information, GPS information, environment information, and personal information in a blockchain, and to manage the history of content so that the history of the content can be tracked.

The NFT may be a non-fungible token that is encrypted to have a unique value for each token by using blockchain technology and cannot be replaced with another token; and the personal information may be projects, business registration numbers, company names, and account information registered for a plurality of consumers or suppliers.

The cloud server may be provided with a directory unit configured to store content, the history of an image acquirer, and one or more followers for each image acquirer, and a content unit configured to provide a plurality of pieces of content, classified by subject, through thumbnails in reverse chronological order of the upload date and time; the directory unit may store one or more comments, a star rating, a like count, a view count, an upload date and time, a sharing count, and various types of social network services (SNSs, e.g., social media) for content for which payment has been completed; the consumer terminal may include a selection unit configured to allow a consumer to search for a plurality of image acquirers and a plurality of pieces of content and to select content suitable for his or her preference, a payment request unit configured to request payment for content selected by the selection unit, and a consumer input unit configured to upload a comment, a like, and/or a star rating, entered by a consumer, when payment is completed; and the platform server may further include a payment unit configured to process payment for content when the payment request unit requests payment for the content, and an event unit configured to host an event for trading the content of a famous photographer or a popular celebrity.

The payment unit may process payment for content to which an NFT has been issued with ERC-20 based on Ethereum, and may process payment for content to which an NFT has not been issued in legal currency; and the payment unit may perform control so that the cloud server transmits selected content and an NFT associated with the content to the selection unit, and may pay a payment amount to the control terminal through a smart contract and register transaction status.

The platform server may further include a first input unit configured to allow an administrator to enter a commentary and evaluation score for content thereinto; the commentary and the evaluation score may be prepared by experts in various fields, such as photographers, university professors, and critics; the evaluation score may be calculated as an average value that is obtained by summing a plurality of evaluation scores entered into the first input unit and then dividing a sum by the number of scores; the platform server may further include a second input unit configured to allow an image acquirer to enter a plurality of suggested words and a description for content in advance thereinto; and the consumer terminal may further include a search unit configured to allow a consumer to search for content related to a keyword in the platform server by entering the keyword.

The platform server may further include a sorting unit configured to calculate similarities to a keyword entered via the search unit and to present a plurality of pieces of content in descending order according to their similarity, upload date and time, like count, and view count; and the sorting unit may compare pluralities of suggested words, descriptions, and commentaries with a keyword entered via the consumer terminal for a plurality of pieces of content stored in the cloud server, and calculate the numbers of appearances of the keyword and one or more words similar to the keyword in the pluralities of suggested words, descriptions, and commentaries for the plurality of pieces of content, may calculate a similarity by multiplying the number of appearances of the keyword, a commentary count, an evaluation score, and a star rating by respective weights and then adding the results of the multiplication for each of the plurality of pieces of content, and may classify the plurality of pieces of content for which similarities have been calculated in descending order according to their upload date and time, like count, and view count, and present a plurality of pieces of content via the search unit in descending order according to their similarity, upload date and time, like count, and view count.

The platform server may further include a sales unit configured to set a sale price and an end price for content to be sold and to also set a sale start date, a sale expiration date, and whether to disclose data related to the content to be sold, an auction unit configured to set a minimum bid for content to be auctioned and to also set an auction start date, and an auction expiration date, and a deposit unit configured to receive a deposit of a specific amount of money from each of a plurality of consumer terminals according to the discretion of a corresponding consumer; the auction unit may notify auction conditions, such as the minimum bid, the auction start date, and the auction expiration date for the content to be auctioned, to a plurality of consumer terminals, collect a plurality of bids from the plurality of consumer terminals, respectively, identify the highest bid having the highest price among the plurality of bids, and then notify permission for a successful bid to a consumer terminal that has offered the highest bid; the sale price may be a single fixed price for one piece of content to be sold; the end price may be a price lowered from the sale price when the sale expiration date has expired or a purchaser for the content to be sold has not been found; the content to be auctioned may be one of a single piece of content and a bundle of pieces of content composed of a plurality of pieces of content; and the selection unit may search for and select content to be auctioned suitable for a consumer's preference among a plurality of pieces of content to be auctioned, and present a bid for the selected content.

According to another aspect of the present invention, there is provided a drone content service method including: a first step of presenting a plurality of pieces of content in descending order of similarity to a keyword entered by a consumer; and a second step in which the consumer purchases drone content suitable for his or her preference; wherein the first step includes: step 1-1 of allowing, by a first input unit, commentaries and evaluation scores of experts for a plurality of pieces of content to be entered thereinto; step 1-2 of allowing, by a second input unit, pluralities of suggested words and descriptions for the plurality of pieces of content to be entered thereinto; step 1-3 of allowing, by a consumer input unit, comments, likes, and star ratings for the plurality of pieces of content to be entered thereinto; step 1-4 of storing the commentaries and evaluation scores of the experts, the suggested words, the descriptions, the likes, and the star ratings for the plurality of pieces of content in a cloud server; step 1-5 of searching for, by a search unit, content related to a keyword in the cloud server based on the keyword entered via the first input unit; step 1-6 of calculating, by a sorting unit, the number of appearances of the keyword and one or more words similar to the keyword in the pluralities of suggested words and descriptions by comparing the pluralities of suggested words, descriptions, and commentaries with the keyword entered via the first input unit for the plurality of pieces of content stored in the cloud server; step 1-7 of calculating, by the sorting unit, a similarity by multiplying the number of appearances of the keyword, a commentary count, an evaluation score, and a star rating for each of the plurality of pieces of content by respective weights and then summing the results of the multiplication; step 1-8 of classifying, by the sorting unit, the plurality of pieces of content for which the similarities have been calculated in descending order according to their upload date and time, like count, and view count; and step 1-9 of presenting, by the sorting unit, the plurality of pieces of content via the search unit in descending order according to their similarity, upload date and time, like count, and view count.

The second step may include: step 2-1 of setting, by a sales unit, a sale price and an end price for content to be sold and also setting, by the sales unit, a sale start date, a sale expiration date, and whether to disclose data related to the content; step 2-2 of setting, by an auction unit, a minimum bid for content to be auctioned and also setting, by the auction unit, an auction start date and an auction expiration date; step 2-3 of notifying, by the sales unit, sales conditions, such as the sale price, the end price, the sale start date, the sale expiration date, and whether to disclose data, for the content to be sold to a plurality of selection units; step 2-4 of notifying, by the auction unit, auction conditions, such as the lowest bid price, the auction start date, and the auction expiration date, for the content to be auctioned to the plurality of selection units; step 2-5 of searching for and selecting, by the plurality of selection units, content suitable for a consumer's preference from among the content to be sold or the content to be auctioned, and presenting, by the plurality of selection units, bids for the content to be auctioned; step 2-6 of collecting, by the auction unit, the plurality of bids from the plurality of selection units, respectively, and identifying, by the auction unit, the highest bid having the highest price among the plurality of bids; step 2-7 of notifying, by the auction unit, permission for a successful bid to the selection unit that has offered the highest bid; step 2-8 of requesting, by a payment request unit, payment for the content to be sold which is selected by the selection unit or the content to be auctioned for which a successful bid has been permitted by the auction unit; step 2-9 of processing, by the payment unit, payment for the content for which payment has been requested by the payment request unit; step 2-10 of performing, by the payment unit, control so that the cloud server transmits the corresponding content for which payment has been processed and an NFT which is associated with the content to the selection unit; step 2-11 of paying, by the payment unit, a payment amount to a control terminal through a smart contract; and step 2-12 of registering, by the payment unit, transaction status in the cloud server.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a conceptual diagram of a drone content service platform according to the present invention;

FIG. 2 is a block diagram of the drone content service platform according to the present invention;

FIG. 3 is a block diagram of the platform server shown in FIG. 2;

FIG. 4 is a block diagram of the process of storing and managing content;

FIG. 5 is a block diagram of the process of presenting content in descending order of similarity to a keyword entered by a consumer;

FIG. 6 is a block diagram of the process in which a consumer purchases content suitable for his or her preference;

FIG. 7 is a block diagram of a drone content service method according to the present invention;

FIG. 8 is a flowchart of the step of presenting a plurality of pieces of content in descending order of similarity to a keyword entered by a consumer;

FIG. 9 is a flowchart of steps S201 to S207 in the step in which the consumer purchases content suitable for his or her preference; and

FIG. 10 is a flowchart of steps S208 to S212 in the step in which the consumer purchases content suitable for his or her preference.

### DETAILED DESCRIPTION

Embodiments of the present invention will be described with reference to the accompanying drawings below in order to describe them in detail so that a person of ordinary skill in the art to which the present invention pertains can easily practice the technical spirit of the present invention.

However, the following embodiments are merely examples intended to help the understanding of the present invention, so that the scope of the present invention is not reduced or limited by them. Furthermore, the present invention may be embodied in various different forms, and is not limited to the embodiments described herein.

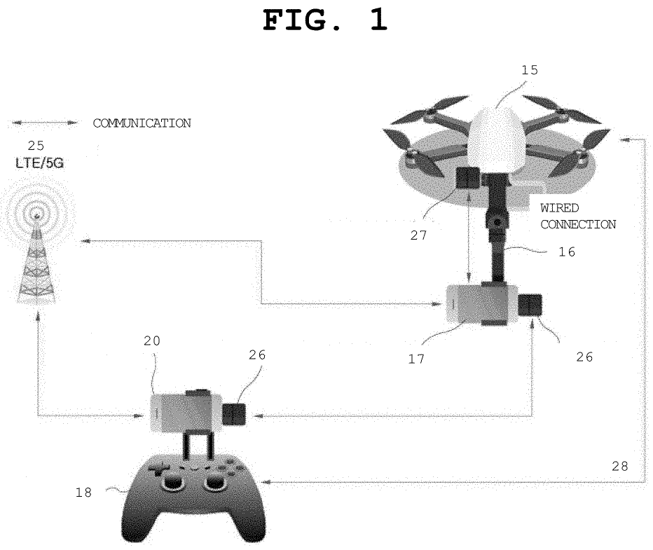

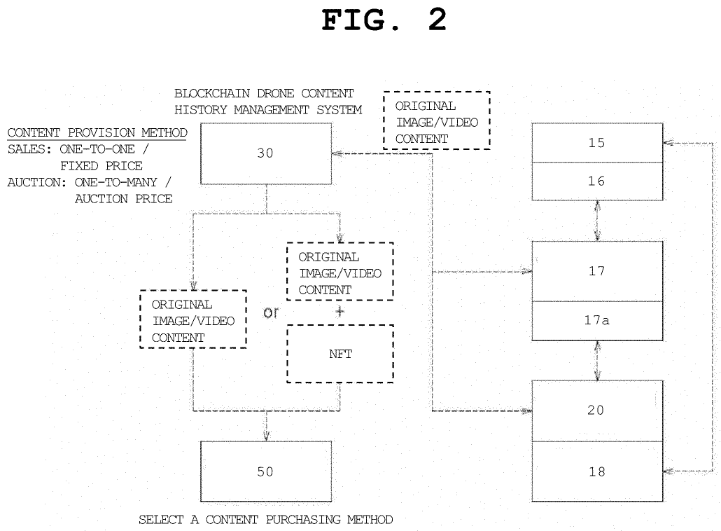

FIG. 1 is a conceptual diagram of a drone content service platform 10 according to the present invention, and FIG. 2 is a block diagram of the drone content service platform 10 according to the present invention.

Referring to FIGS. 1 and 2, the drone content service platform 10 according to the present invention is configured to include a drone 15, an image acquisition terminal 17, a drone controller 18, a control terminal 20, a wireless communication module 25, a Bluetooth module 27, an RF communication 28, a platform server 30, and a consumer terminal 50.

First, the drone 15 is provided with a gimbal 16 capable of removing the blurring of an image or video content by maintaining a balanced posture regardless of the tilt and vibration of the drone 15 beneath it.

Furthermore, the image acquisition terminal 17 is provided under the gimbal 16, and acquires an image or video content via a camera 17a mounted on one side of the image acquisition terminal 17.

In this case, in the image acquisition terminal 17, the content acquired by the camera 17a is automatically stored, and whether to transmit the content to the platform server 30 may be selected.

Furthermore, the drone controller 18 controls the flight of the drone 15.

Furthermore, the control terminal 20 is mounted over the drone controller 18. The control terminal 20 controls the image acquisition terminal 17 so that the camera 17a of the image acquisition terminal 17 can acquire content based on a signal input by an image acquirer, and monitors the content acquired by the camera 17a. In addition, the control terminal 20 serves to transfer various types of signals to the image acquisition terminal 17.

Furthermore, the wireless communication module 25 serves to transmit and receive signals between the image acquisition terminal 17 and the control terminal 20. In this case, the wireless communication module may be implemented based on Long Term Evolution (LTE) or 5th Generation Mobile Telecommunication (5G).

Meanwhile, communication modems 26 are mounted on respective sides of the image acquisition terminal 17 and the control terminal 20, and may transmit and receive signals between the image acquisition terminal 17 and the control terminal 20 when the wireless communication module 25 is not operated desirably.

Furthermore, the RF communication 28 transmits a gimbal control signal, generated by the drone controller 18, to the drone 15. In this case, the gimbal control signal refers to a signal that is generated by the drone controller 18 to control the gimbal 16.

Furthermore, the drone 15 and the gimbal 16 may be connected to each other via wired communication, and may transmit and receive gimbal control signals and power signals via wired communication.

Meanwhile, the control between the control terminal 20 and the image acquisition terminal 17 may be performed via control applications 21 that are installed on both the terminals 20 and 17, respectively.

In addition, the control between the control terminal 20 and the image acquisition terminal 17 may be performed via a remote support application 22 that is installed on the control terminal 20 and controls the screen of the image acquisition terminal 17.

Meanwhile, the Bluetooth module 27 is mounted on one side of the drone 15, and transmits drone information, GPS information, and environment information for the history management of the drone 15 to the image acquisition terminal 17. The drone information, GPS information, and environment information transmitted by the Bluetooth module 27 are automatically stored in the image acquisition terminal 17.

In this case, the drone information refers to the type of drone, and the owner information, flight date and time, etc. of the drone, the GPS information refers to the altitude, longitude, latitude, etc. of a flight area, and the environment information refers to the temperature, humidity, weather, etc. of the flight area.

Furthermore, the drone information, the GPS information, and the environment information are automatically stored in the history management unit 34 of the platform server 30 later.

Furthermore, the platform server 30 manages a plurality of pieces of content acquired by the camera 17a based on a blockchain.

In this case, the blockchain refers to a distributed digital ledger that shares content with all participants (nodes equipped with specific conditions), unlike the existing method of keeping records in a centralized server during data transactions.

Furthermore, the consumer terminal 50 is connected to the platform server 30 through a wireless communication module, and performs content selection and payment request tasks based on signals input by a consumer.

In this case, the consumer terminal 50 may be implemented as a smartphone, a desktop computer, a laptop computer, a notebook computer, or the like.

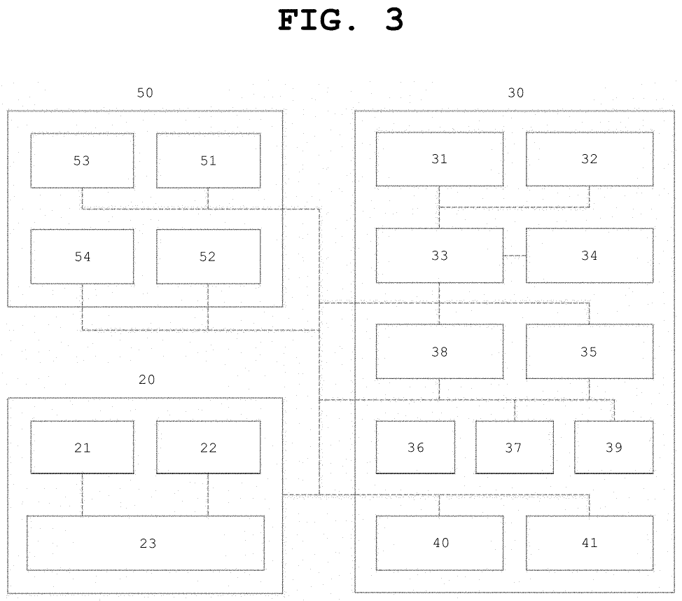

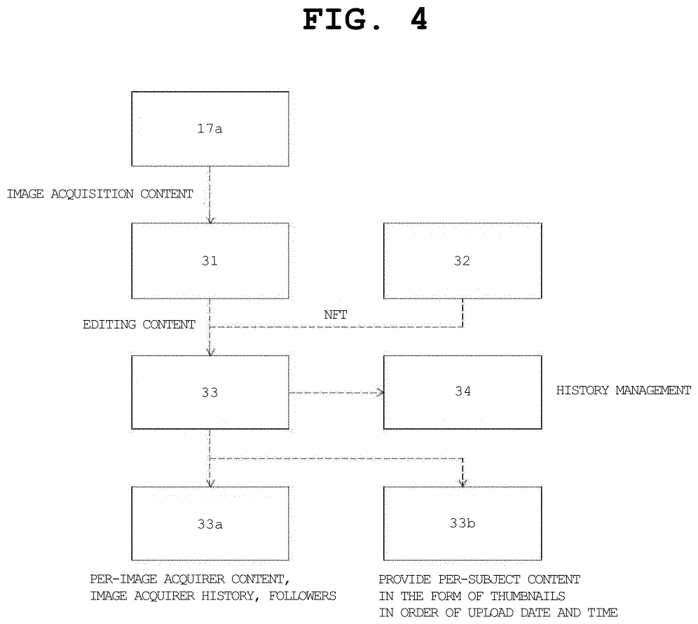

FIG. 3 is a block diagram of the platform server 30 shown in FIG. 2, and FIG. 4 is a block diagram of the process of storing and managing content.

Referring to FIGS. 3 and 4, the platform server 30 is configured to include an editing unit 31, a token issuance unit 32, a cloud server 33, and a history management unit 34.

First, the editing unit 31 edits acquired content.

Furthermore, the token issuance unit 32 issues a non-fungible token (NFT) by using the Ethereum Request for Comment 721 (ERC-721) protocol that is used in an Ethereum network in response to a request from an image acquirer.

In this case, the NFT refers to a non-fungible token that is encrypted to have a unique value for each token by using blockchain technology and cannot be replaced with another token. Specific content may be certified by an NFT as being an original and not a duplicate.

Furthermore, content edited by the editing unit 31 and an NFT issued to the content are stored in the cloud server 33.

Furthermore, the cloud server 33 is provided with a directory unit 33a configured to store information about an image acquirer, such as content, the history of the image acquirer, and one or more followers, is stored for each image acquirer.

In addition, the directory unit 33a stores one or more comments, a star rating, a like count, a view count, an upload date and time, a sharing count, various types of social network services (SNSs), and the like for the content for which payment has been completed.

In addition, the cloud server 33 is provided with a content unit 33b configured to provide a plurality of pieces of content, classified by subject, through thumbnails in reverse chronological order of the upload date and time.

Furthermore, the history management unit 34 manages a history related to data stored in the cloud server 33. In addition, the history management unit 34 registers and manages drone information, GPS information, environment information, and personal information in a blockchain, and manages a history of content so that the history of the content can be tracked.

In this case, the drone information refers to the type of drone, and the owner information, flight date and time, etc. of the drone, the GPS information refers to the altitude, longitude, latitude, etc. of a flight area, and the environment information refers to the temperature, humidity, weather, etc. of the flight area.

Furthermore, the personal information refers to projects, business registration numbers, company names, account information, etc. registered for a plurality of consumers or suppliers.

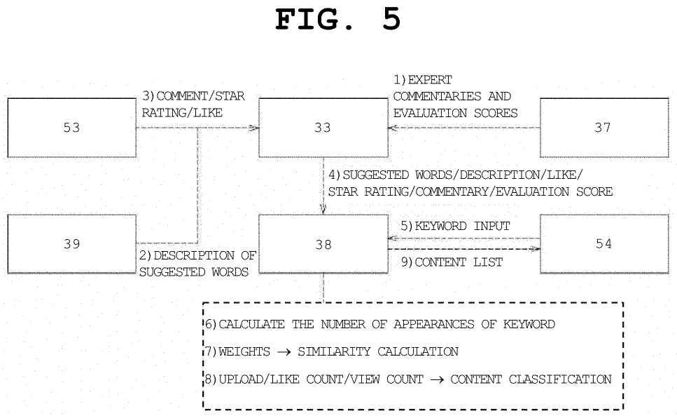

FIG. 5 is a block diagram of the process of presenting content in descending order of similarity to a keyword entered by a consumer.

Referring to FIGS. 2 and 5, the consumer terminal 50 is configured to further include a selection unit 51, a payment request unit 52, and a consumer input unit 53.

First, via the selection unit 51, a consumer may log in through a personal ID and password after accessing the directory unit 33a of the cloud server 33.

Furthermore, via the selection unit 51, the consumer may search for a plurality of image acquirers and a plurality of pieces of content in the directory unit 33a, and may select content suitable for his or her preference.

In this case, when content is selected, one of content, and content and an NFT may be selected according to a consumer's preference via the selection unit 51.

In addition, via the selection unit 51, a consumer may check one or more comments, a star rating, a like count, a view count, an upload date and time, a sharing count, etc. for each piece of content, and may check the history and followers of an image acquirer for each image acquirer.

Furthermore, via the selection unit 51, a consumer may easily share corresponding content through links of Facebook, Twitter, Pinterest, e-mail, and/or the like.

In addition, the payment request unit 52 requests payment for content selected by the selection unit 51.

In addition, the consumer input unit 53 uploads a comment, a like, and/or a star rating, entered by a consumer, to the cloud server 33 when payment is completed.

Through this, in the future, when selecting content, other consumers may refer to comments, a like count, a star rating count, and/or the like for content and use them as criteria for purchasing the content.

Furthermore, the platform server 30 is configured to further include a payment unit 35 and an event unit 36.

Furthermore, the payment unit 35 processes payment for content when the payment request unit 52 requests payment for the content.

Furthermore, when processing payment for content, the payment unit 35 processes payment for content to which an NFT has been issued with ERC-20 based on Ethereum, and processes payment for content to which an NFT has not been issued in legal currency.

Thereafter, the payment unit 35 performs control so that the cloud server 33 transmits the selected content and the NFT associated with the content to the selection unit 51.

Thereafter, the payment unit 35 pays a payment amount to the control terminal 20 through a smart contract, and registers transaction status.

In this case, the smart contract refers to a technology by which a transaction is automatically concluded between parties when predetermined conditions for a transaction are satisfied in Distributed Ledger Technology (DLT) (e.g., a blockchain).

Meanwhile, the consumer input unit 53 may upload a comment, a like, and a star rating, entered by a consumer, to the cloud server 33 when payment is completed.

Furthermore, the event unit 36 may host an event for trading content of a famous photographer, a popular celebrity, or the like.

Consumers may access a wide variety of pieces of high-quality content via the event unit 36, and also an administrator may increase the consumer awareness of the drone content service platform 10 and consumer confidence in the drone content service platform 10 via the event unit 36.

Referring to FIG. 5, the platform server 30 may be configured to further include a first input unit 37 configured to allow an administrator to enter a commentary and evaluation score for content thereinto. In this case, the commentary and evaluation score for the content entered into the first input unit 37 are stored in the cloud server 33.

Furthermore, the commentary and evaluation score for the content may be prepared by experts in various fields, such as photographers, university professors, critics, and/or the like. In addition, the evaluation score may be calculated as an average value that is obtained by summing a plurality of evaluation scores entered into the first input unit 37 and then dividing a sum by the number of scores.

Through this, a consumer may select the content in which the fairness of evaluation and confidence in evaluation are secured from among a plurality of pieces of content.

Meanwhile, the platform server 30 may be configured to further include a second input unit 39 configured to allow an image acquirer to enter a plurality of suggested words, a description, and/or the like for content in advance thereinto.

In this case, the suggested words, the description, and/or the like entered into the second input unit 39 of the platform server 30 are stored in the cloud server 33 of the platform server 30.

Furthermore, the consumer terminal 50 is configured to further include a search unit 54 configured to allow a consumer to search for content related to a keyword in the platform server 30 by entering the keyword. In this case, the keyword entered into the search unit 54 of the consumer terminal 50 is transmitted to the sorting unit 38 of the platform server 30.

Furthermore, the platform server 30 is configured to further include the sorting unit 38 configured to calculate similarities to a keyword entered via the search unit 54 and to present a plurality of pieces of content in descending order according to their similarity, upload date and time, like count, and view count.

More specifically, the sorting unit 38 compares pluralities of suggested words, descriptions, and commentaries with a keyword entered via the consumer terminal for a plurality of pieces of content stored in the cloud server 33, and calculates the numbers of appearances of the keyword and one or more words similar to the keyword in the pluralities of suggested words, descriptions, and commentaries for the plurality of pieces of content.

Furthermore, the sorting unit 38 calculates a similarity by multiplying the number of appearances of the keyword, a commentary count, an evaluation score, and a star rating by respective weights and then adding the results of the multiplication for each of the plurality of pieces of content.

Furthermore, the sorting unit 38 classifies the plurality of pieces of content for which similarities have been calculated in descending order according to their upload date and time, like count, and view count.

Furthermore, the sorting unit 38 presents the plurality of pieces of content via the search unit 54 in descending order according to their similarity, upload date and time, like count, and view count.

For example, the sorting unit 38 calculates a similarity by multiplying the number of appearances of a keyword, a commentary count, an evaluation score, and a star rating by weights of 60%, 16%, 12%, and 12%, respectively, and then adding the results of the multiplication for each of a plurality of pieces of content.

Furthermore, the sorting unit 38 may classify a plurality of pieces of content for which similarities have been calculated in descending order according to their upload date and time, like count, and view count, and may present the plurality of pieces of content via the search unit 54 in descending order according to their similarity, upload date and time, like count, and view count.

Through this process, a consumer may select high-quality content desired by him or her from among a plurality of pieces of content.

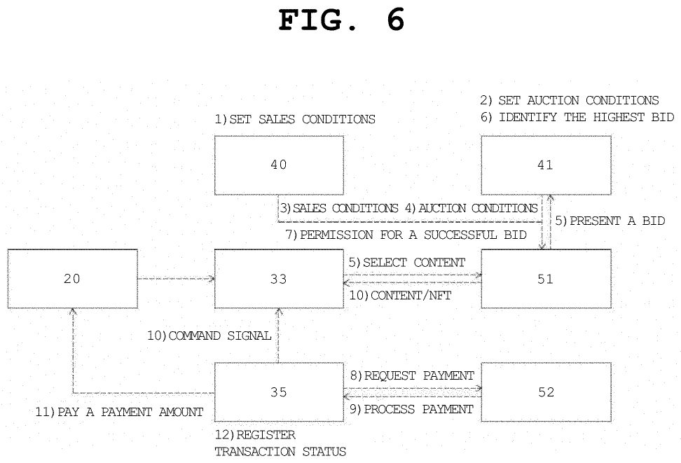

FIG. 6 is a block diagram of the process in which a consumer purchases content suitable for his or her preference.

Referring to FIG. 6, the platform server is configured to further include a sales unit 40 and an auction unit 41.

First, the sales unit 40 sets a sale price and an end price for content to be sold, and also sets a sale start date, a sale expiration date, and whether to disclose data related to the content to be sold.

In this case, the sale price refers to a single fixed price for one piece of content to be sold, and the end price refers to a price lowered from the sale price when the sale expiration date has expired or when a purchaser for the content to be sold has not been found.

Furthermore, the auction unit 41 sets a minimum bid for content to be auctioned, and also sets an auction start date and an auction expiration date.

Furthermore, the auction unit 41 notifies auction conditions, such as the minimum bid, the auction start date, and the auction expiration date for the content to be auctioned, to a plurality of consumer terminals 50, and collects a plurality of bids from the plurality of consumer terminals 50, respectively.

Furthermore, the auction unit 41 identifies the highest bid having the highest price among the plurality of bids, and then notifies permission for a successful bid to the consumer terminal 50 that has offered the highest bid.

In this case, the content to be auctioned may be one of a single piece of content and a bundle of pieces of content composed of a plurality of pieces of content.

Furthermore, a deposit unit 43 receives a deposit of a specific amount of money from each of the plurality of consumer terminals 50 according to the discretion of a corresponding consumer.

Meanwhile, when a bid more than a deposit is not presented, an auction for specific content may be ended without notification.

Meanwhile, the selection unit 51 of the consumer terminal 50 may search for and select content to be auctioned suitable for a consumer's preference among the plurality of pieces of content to be auctioned, and may present a bid for the selected content.

Next, a drone content service method according to the present invention will be described.

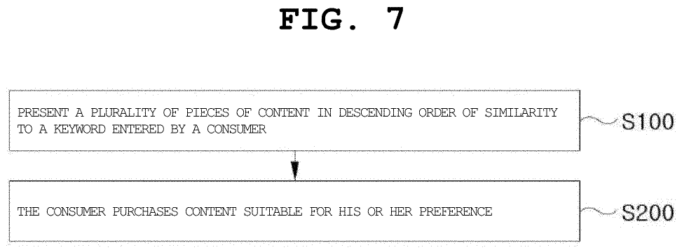

FIG. 7 is a block diagram of a drone content service method according to the present invention.

Referring to FIG. 7, the drone content service method according to the present invention is configured to include step S100 of presenting a plurality of pieces of content in descending order of similarity to a keyword entered by a consumer and step S200 in which the consumer purchases drone content suitable for his or her preference.

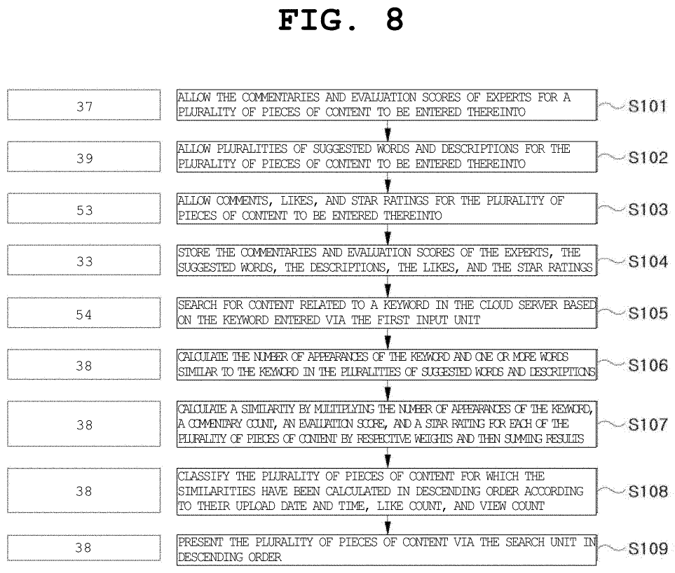

FIG. 8 is a flowchart of the step of presenting a plurality of pieces of content in descending order of similarity to a keyword entered by a consumer.

Referring to FIG. 8, step S100 of presenting a plurality of pieces of content in descending order of similarity to a keyword entered by a consumer is as follows:

First, the first input unit 37 allows the commentaries and evaluation scores of experts for a plurality of pieces of content to be entered thereinto in step S101.

Thereafter, the second input unit 39 allows pluralities of suggested words and descriptions for the plurality of pieces of content to be entered thereinto in step S102.

Thereafter, the consumer input unit 53 allows comments, likes, and star ratings for the plurality of pieces of content to be entered thereinto in step S103.

Thereafter, the commentaries and evaluation scores of the experts, the suggested words, the descriptions, the likes, and the star ratings for the plurality of pieces of content are stored in the cloud server 33 in step S104.

Thereafter, the search unit 54 searches for content related to a keyword in the cloud server 33 based on the keyword entered via the first input unit 37 in step S105.

Thereafter, the sorting unit 38 calculates the number of appearances of the keyword and one or more words similar to the keyword in the pluralities of suggested words and descriptions by comparing the pluralities of suggested words, descriptions, and commentaries with the keyword entered via the first input unit 37 for the plurality of pieces of content stored in the cloud server 33 in step S106.

Thereafter, the sorting unit 38 calculates a similarity by multiplying the number of appearances of the keyword, a commentary count, an evaluation score, and a star rating by respective weights and then summing the results of the multiplication for each of the plurality of pieces of content in step S107.

Thereafter, the sorting unit 38 classifies the plurality of pieces of content for which the similarities have been calculated in descending order according to their upload date and time, like count, and view count in step S108.

Thereafter, the sorting unit 38 presents the plurality of pieces of content via the search unit 54 in descending order according to their similarity, upload date and time, like count, and view count in step S109.

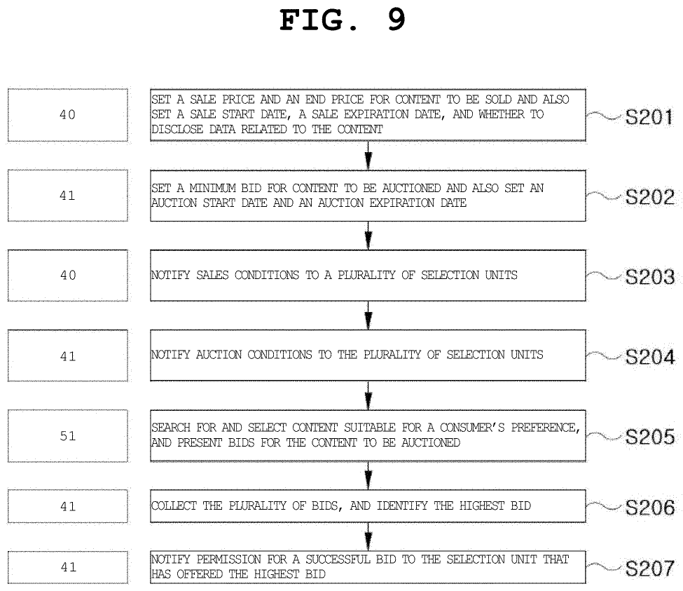

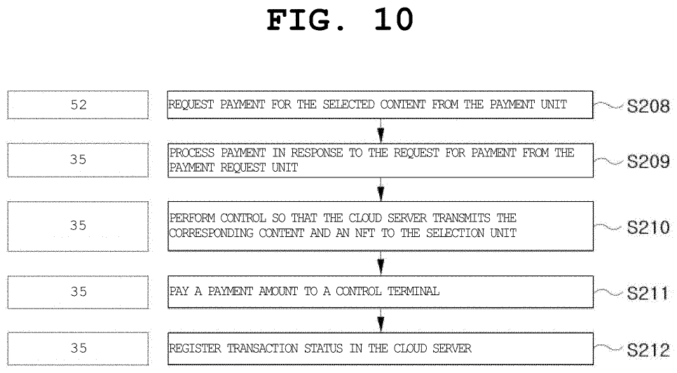

FIG. 9 is a flowchart of steps S201 to S207 in the step in which the consumer purchases content suitable for his or her preference, and FIG. 10 is a flowchart of steps S208 to S212 in the step in which the consumer purchases content suitable for his or her preference.

Referring to FIGS. 9 and 10, the step in which a consumer purchases drone content suitable for his or her preference is as follows:

First, the sales unit 40 sets a sale price and an end price for content to be sold and also sets a sale start date, a sale expiration date, and whether to disclose data related to the content in step S201.

Thereafter, the auction unit 41 sets a minimum bid for content to be auctioned and also sets an auction start date and an auction expiration date in step S202.

Thereafter, the sales unit 40 notifies sales conditions, such as the sale price, the end price, the sale start date, the sale expiration date, and whether to disclose data, for the content to be sold to the plurality of selection units 51 in step S203.

Thereafter, the auction unit 41 notifies auction conditions, such as the lowest bid price, the auction start date, and the auction expiration date, for the content to be auctioned to the plurality of selection units 51 in step S204.

Thereafter, the plurality of selection units 51 searches for and selects content suitable for a consumer's preference from among the content to be sold or the content to be auctioned, and proposes bids for the content to be auctioned in step S205.

Thereafter, the auction unit 41 collects the plurality of bids from the plurality of selection units 51, respectively, and identifies the highest bid having the highest price among the plurality of bids in step S206.

Thereafter, the auction unit 41 notifies permission for a successful bid to the selection unit 51 that has offered the highest bid in step S207.

The payment request unit 52 requests payment for the content to be sold which is selected by the selection unit 51 or the content to be auctioned for which a successful bid has been permitted by the auction unit 41 in step S208.

Thereafter, the payment unit 35 processes payment for the content for which payment has been requested by the payment request unit 52 in step S209.

Thereafter, the payment unit 35 performs control so that the cloud server 33 transmits the corresponding content and an NFT associated with the content to the selection unit 51 in step S210.

Thereafter, the payment unit 35 pays a payment amount to the control terminal 20 through a smart contract in step S211.

Thereafter, the payment unit 35 registers transaction status in the cloud server 33 in step S212.

The present invention is advantageous in that the drone content service platform 10 according to the present invention can supply content, acquired directly by an image acquirer using the camera 17a mounted on the drone 15, in a timely manner according to a consumer's request, so that the consumer can be provided with high-quality content.

Furthermore, the present invention is advantageous in that in the drone content service platform 10 according to the present invention, an image or video content, acquired directly by an image acquirer using the camera 17a of the image acquisition terminal 17 mounted on the drone is automatically uploaded to the blockchain-based platform server 30, the platform server 30 issues and manages an NFT for the content, and a consumer can purchase a plurality of pieces of content, managed by the platform server 30, through payment using currency or coins, so that the copyright on the content can be protected and the profits of the image acquirer who sells the content can be improved.

Moreover, the present invention is advantageous in that the drone content service platform according to the present invention can present a plurality of pieces of content in descending order of similarity to a keyword entered by a consumer, so that the consumer can select high-quality content desired by him or her from among the plurality of pieces of content.

As described above, the present invention is chiefly intended to provide the drone content service platform 10 and the drone content service method. The embodiments described above with reference to the accompanying drawings are only examples, and the true scope of the present invention is based on the claims, but will also extend to equivalent embodiments that may be present in various forms.

### LIST OF REFERENCE NUMERALS

10: drone content service platform
15: drone
16: gimbal
17: image acquisition terminal
17a: camera
18: drone controller
20: control terminal
21: control app
22: remote support app
23: display unit
25: wireless communication module
26: communication modem
27: Bluetooth module
28: RF communication
30: platform server
31: editing unit
32: token issuance unit
33: cloud server
33a: directory unit
33b: content unit
34: history management unit
35: payment unit
36: event unit
37: first input unit
38: sorting unit
39: second input unit
40: sales unit
41: auction unit
50: consumer terminal
51: selection unit
52: payment request unit
53: consumer input unit
54: search unit

What is claimed is:

1. A drone content service platform comprising:
a drone provided with a gimbal capable of removing blurring of an image or video content by maintaining a balanced posture regardless of tilt and vibration;
an image acquisition terminal provided under the gimbal, and configured to acquire an image or video content via a camera mounted on one side thereof;
a drone controller configured to control flight of the drone;
a control terminal connected to the image acquisition terminal, and configured to control the image acquisition terminal to allow the camera to acquire content based on a signal input by an image acquirer and to monitor the content acquired by the camera;
a wireless communication module configured to transmit and receive signals between the image acquisition terminal and the control terminal;
a Bluetooth module configured to transmit drone information, Global Positioning System (GPS) information, and environment information for history management of the drone to the image acquisition terminal;
an radio frequency (RF) communication configured to transmit gimbal control signals, generated by the drone controller, to the drone;
a platform server configured to manage a plurality of pieces of content, acquired by the camera, based on a blockchain; and
a consumer terminal connected to the platform server through the wireless communication module, and configured to perform content selection and payment request tasks based on signals input by a consumer,
wherein, in the image acquisition terminal, content acquired by the camera is automatically stored and also whether to transmit the content to the platform server is selectable,
wherein the control terminal is one of a smartphone or smart watch,
wherein the drone and the gimbal are connected to each other via wired communication, and transmit and receive gimbal control signals and power signals via wired communication,
wherein the drone information is a type of drone, and owner information and flight date and time of the drone,
wherein the GPS information is an altitude, longitude, and latitude of a flight area, and
wherein the environment information is a temperature, humidity, and weather of the flight area.

2. The drone content service platform of claim 1, wherein the platform server comprises:
a transceiver configured to transmit and receive data between the platform server and the drone and between the control terminal and the consumer terminal;
an editing unit configured to edit content acquired by the camera;
a token issuance unit configured to issues a non-fungible token (NFT) to content in response to a request from an image acquirer;
a cloud server configured to store content edited by the editing unit and an NFT issued to the content; and
a history management unit configured to register and manage pluralities of pieces of drone information, GPS information, environment information, and personal information in a blockchain, and to manage a history of content to allow the history of the content to be tracked.

3. The drone content service platform of claim 2, wherein the NFT is a non-fungible token that is encrypted to have a unique value for each token by using blockchain technology and unable to be replaced with another token, and
wherein the personal information is projects, business registration numbers, company names, and account information registered for a plurality of consumers or suppliers.

4. The drone content service platform of claim 2, wherein the cloud server is provided with a directory unit configured to store content, a history of an image acquirer, and one or more followers for each image acquirer, and a content unit configured to provide a plurality of pieces of content, classified by subject, through thumbnails in reverse chronological order of upload date and time,
wherein the directory unit stores one or more comments, a star rating, a like count, a view count, an upload date and time, a sharing count, and various types of social network services (SNSs) for content for which payment has been completed,
wherein the consumer terminal comprises:
a selection unit configured to allow a consumer to search for a plurality of image acquirers and a plurality of pieces of content and to select content suitable for his or her preference;
a payment request unit configured to request payment for content selected by the selection unit; and
a consumer input unit configured to upload a comment, a like, and/or a star rating, entered by a consumer, when payment is completed, and
wherein the platform server further comprises:
a payment unit configured to process payment for content when the payment request unit requests payment for the content; and
an event unit configured to host an event for trading content of a famous photographer or a popular celebrity.

5. The drone content service platform of claim 4, wherein the payment unit processes payment for content to which an NFT has been issued with ERC-20 based on Ethereum, and processes payment for content to which an NFT has not been issued in legal currency, and
wherein the payment unit:
performs control so that the cloud server transmits selected content and an NFT associated with the content to the selection unit; and
pays a payment amount to the control terminal through a smart contract, and registers transaction status.

6. The drone content service platform of claim 1, wherein the platform server further comprises a first input unit configured to allow an administrator to enter a commentary and evaluation score for content thereinto,
wherein the commentary and the evaluation score are prepared by experts in various fields,
wherein the evaluation score is calculated as an average value that is obtained by summing a plurality of evaluation scores entered into the first input unit and then dividing a sum by a number of scores,
wherein the platform server further comprises a second input unit configured to allow an image acquirer to enter a plurality of suggested words and a description for content in advance thereinto, and
wherein the consumer terminal further comprises a search unit configured to allow a consumer to search for content related to a keyword in the platform server by entering the keyword.

7. The drone content service platform of claim 6, wherein the platform server further comprises a sorting unit configured to calculate similarities to a keyword entered via the search unit and to present a plurality of pieces of content in descending order according to their similarity, upload date and time, like count, and view count, and
wherein the sorting unit:
compares pluralities of suggested words, descriptions, and commentaries with a keyword entered via the consumer terminal for a plurality of pieces of content stored in the cloud server, and calculates numbers of appearances of the keyword and one or more words similar to the keyword in the pluralities of suggested words, descriptions, and commentaries for the plurality of pieces of content;
calculates a similarity by multiplying a number of appearances of the keyword, a commentary count, an evaluation score, and a star rating by respective weights and then adding results of the multiplication for each of the plurality of pieces of content; and
classifies the plurality of pieces of content for which similarities have been calculated in descending order according to their upload date and time, like count, and view count, and presents a plurality of pieces of content via the search unit in descending order according to their similarity, upload date and time, like count, and view count.

8. The drone content service platform of claim 7, wherein the platform server further comprises:
a sales unit configured to set a sale price and an end price for content to be sold, and to also set a sale start date, a sale expiration date, and whether to disclose data related to the content to be sold;
an auction unit configured to set a minimum bid for content to be auctioned, and to also set an auction start date, and an auction expiration date; and
a deposit unit configured to receive a deposit of a specific amount of money from each of a plurality of consumer terminals according to discretion of a corresponding consumer,
wherein the auction unit notifies auction conditions for the content to be auctioned to a plurality of consumer terminals, collects a plurality of bids from the plurality of consumer terminals, respectively, identifies a highest bid having a highest price among the plurality of bids, and then notifies permission for a successful bid to a consumer terminal that has offered the highest bid,
wherein the sale price is a single fixed price for one piece of content to be sold,
wherein the end price is a price lowered from the sale price when the sale expiration date has expired or a purchaser for the content to be sold has not been found,
wherein the content to be auctioned is one of a single piece of content or a bundle of pieces of content composed of a plurality of pieces of content, and
wherein the selection unit searches for and selects content to be auctioned suitable for a consumer's preference among a plurality of pieces of content to be auctioned, and presents a bid for the selected content.

9. A drone content service method comprising:
a first step of presenting a plurality of pieces of content in descending order of similarity to a keyword entered by a consumer; and
a second step in which the consumer purchases drone content suitable for his or her preference,
wherein the first step comprises:
step 1-1 of allowing, by a first input unit, commentaries and evaluation scores of experts for a plurality of pieces of content to be entered thereinto;
step 1-2 of allowing, by a second input unit, pluralities of suggested words and descriptions for the plurality of pieces of content to be entered thereinto;
step 1-3 of allowing, by a consumer input unit, comments, likes, and star ratings for the plurality of pieces of content to be entered thereinto;
step 1-4 of storing the commentaries and evaluation scores of the experts, the suggested words, the descriptions, the likes, and the star ratings for the plurality of pieces of content in a cloud server;
step 1-5 of searching for, by a search unit, content related to a keyword in the cloud server based on the keyword entered via the first input unit;
step 1-6 of calculating, by a sorting unit, a number of appearances of the keyword and one or more words similar to the keyword in the pluralities of suggested words and descriptions by comparing the pluralities of suggested words, descriptions, and commentaries with the keyword entered via the first input unit for the plurality of pieces of content stored in the cloud server;
step 1-7 of calculating, by the sorting unit, a similarity by multiplying the number of appearances of the keyword, a commentary count, an evaluation score, and a star rating for each of the plurality of pieces of content by respective weights and then summing results of the multiplication;
step 1-8 of classifying, by the sorting unit, the plurality of pieces of content for which the similarities have been calculated in descending order according to their upload date and time, like count, and view count; and
step 1-9 of presenting, by the sorting unit, the plurality of pieces of content via the search unit in descending order according to their similarity, upload date and time, like count, and view count.

10. The drone content service method of claim 9, wherein the second step comprises:
step 2-1 of setting, by a sales unit, a sale price and an end price for content to be sold and also setting, by the sales unit, a sale start date, a sale expiration date, and whether to disclose data related to the content;
step 2-2 of setting, by an auction unit, a minimum bid for content to be auctioned and also setting, by the auction unit, an auction start date and an auction expiration date;
step 2-3 of notifying, by the sales unit, sales conditions, and whether to disclose data, for the content to be sold to a plurality of selection units;
step 2-4 of notifying, by the auction unit, auction conditions for the content to be auctioned to the plurality of selection units;
step 2-5 of searching for and selecting, by the plurality of selection units, content suitable for a consumer's preference from among the content to be sold or the content to be auctioned, and presenting, by the plurality of selection units, bids for the content to be auctioned;
step 2-6 of collecting, by the auction unit, the plurality of bids from the plurality of selection units, respectively, and identifying, by the auction unit, a highest bid having a highest price among the plurality of bids;
step 2-7 of notifying, by the auction unit, permission for a successful bid to the selection unit that has offered the highest bid;
step 2-8 of requesting, by a payment request unit, payment for the content to be sold which is selected by the selection unit or the content to be auctioned for which a successful bid has been permitted by the auction unit;
step 2-9 of processing, by the payment unit, payment for the content for which payment has been requested by the payment request unit;
step 2-10 of performing, by the payment unit, control so that the cloud server transmits the corresponding content for which payment has been processed and an NFT which is associated with the content to the selection unit;
step 2-11 of paying, by the payment unit, a payment amount to a control terminal through a smart contract; and
step 2-12 of registering, by the payment unit, transaction status in the cloud server.
